(19) United States
(12) Patent Application Publication
(10) Pub. No.: US 2012/0182613 A1
(43) Pub. Date: Jul. 19, 2012

(54) SHUTTER GLASSES AND IMAGE DISPLAY SYSTEM

(75) Inventor: Kunio YONENO, Shiojiri-shi (JP)

(73) Assignee: SEIKO EPSON CORPORATION, TOKYO (JP)

(21) Appl. No.: 13/348,121

(22) Filed: Jan. 11, 2012

(30) Foreign Application Priority Data
Jan. 19, 2011 (JP) 2011-009050

(51) Int. Cl. G02B 27/26; G02B 27/22

(52) U.S. Cl. 359/465; 359/464

(57) ABSTRACT

Shutter glasses include a left-eye selection part and a right-eye selection part that respectively switch to a transmission state or a blocking state, a tilt detection part that detects a tilt condition of the shutter glasses, a tilt condition determination part that compares an output value of the tilt detection part and a predetermined threshold value, a signal acquisition part that acquires a left switch signal in synchronization with the image for left eye and a right switch signal in synchronization with the image for right eye, and a switching operation part that switches the left-eye selection part and the right-eye selection part to the transmission state or the blocking state. When the output value is equal to or more than the threshold value, the switching operation part switches both the left-eye and the right-eye selection parts in response to one of the left and the right switch signal.

### BACKGROUND

1. Technical Field

The present invention relates to shutter glasses and an image display system.

2. Related Art

In related art, an image display system (stereoscopic image display apparatus) including an image display device that displays images and shutter glasses worn by an observer for stereoscopic viewing of displayed images displayed in the image display device through the shutter glasses has been known (for example, see Patent Document 1 (JP-A-2009-232249).

In the image display system disclosed in Patent Document 1, the image display device displays an image for left eye in a first display period and displays an image for right eye in a second display period, and time-divisionally and alternately displays the image for left eye and the image for right eye with respect to each display period.

Further, the shutter glasses include the so-called liquid crystal shutters, and the left-eye shutter and the right-eye shutter alternately change between a transmission state of transmitting light and a blocking state of blocking the light in synchronization with the time-divisional driving of the image display device described above.

Accordingly, the observer visually recognizes the image for left eye with the left eye in the first display period, visually recognizes the image for right eye with the right eye in the second display period, and stereoscopically views the displayed images because of parallax through the shutter glasses.

The above described displayed images (the image for left eye, the image for right eye) are arranged to be stereoscopically viewed by providing parallax and convergence between the right and the left. That is, there is a precondition that the left eye and the right eye of the observer are located in parallel to the horizontal direction.

When the observer takes a position of tilting the face, the right and left eyes are tilted relative to the horizontal direction and the observer may not stereoscopically view the displayed images in good condition through the shutter glasses. That is, there is a problem that, in the above described position, the observer may feel uncomfortable.

### SUMMARY

An advantage of some aspects of the invention is to provide shutter glasses and an image display system that can realize good visual recognition of displayed images.

An aspect of the invention is directed to shutter glasses used for an image display system having an image display device of alternately displaying an image for left eye and an image for right eye and including a left-eye selection part and a right-eye selection part for switching to a transmission state of transmitting light or a blocking state of blocking light, and the shutter glasses include a tilt detection part that detects a tilt condition of the shutter glasses, a signal acquisition part that acquires a left switch signal in synchronization with display timing of the image for left eye and a right switch signal in synchronization with display timing of the image for right eye from the image display device, a tilt condition determination part that compares an output value of the tilt detection part and a predetermined threshold value, and a switching operation part that switches the left-eye selection part and the right-eye selection part to the transmission state or the blocking state, wherein, when the output value is less than the threshold value, the switching operation part switches only the left-eye selection part from the blocking state to the transmission state in response to acquisition timing of the left switch signal and switches only the right-eye selection part from the blocking state to the transmission state in response to acquisition timing of the right switch signal, and, when the output value is equal to or more than the threshold value, the switching operation part switches both the left-eye selection part and the right-eye selection part from the blocking state to the transmission state in response to acquisition timing of one of the left switch signal and the right switch signal.

In the aspect of the invention, since the shutter glasses include the above described tilt detection part, signal acquisition part, tilt condition determination part, and switching operation part, an observer may visually recognize the displayed images by the image display device through the shutter glasses as will be described below.

For example, when the tilt of the shutter glasses is smaller as in the case where the left eye and the right eye of the observer are located nearly in parallel to the horizontal direction (the output value of the tilt detection part is less than the predetermined threshold value), the left-eye selection part switches to the transmission state and the right-eye selection part switches to the blocking state in response to the acquisition timing of the left switch signal. Further, the right-eye selection part switches to the transmission state and the left-eye selection part switches to the blocking state in response to the acquisition timing of the right switch signal.

Therefore, when the tilt of the shutter glasses is smaller, the observer stereoscopically views the displayed images because of parallax by visually recognizing the image for left eye with the left eye only and visually recognizing the image for right eye with the right eye only.

On the other hand, when the tilt of the shutter glasses is larger as in the case where the observer tilts the face or the like (when the output value of the tilt detection part is equal to or more than the predetermined threshold value), both the left-eye selection part and the right-eye selection part switch to the transmission state in response to acquisition timing of one of the left switch signal and the right switch signal.

That is, both the left-eye selection part and the right-eye selection part may be switched to the transmission state when one of the image for left eye and the image for right eye is displayed and both the left-eye selection part and the right-eye selection part may be switched to the blocking state when the other of the image for left eye and the image for right eye is displayed.

Therefore, if the tilt of the shutter glasses is larger, the observer may visually recognize only one of the image for left eye and the image for right eye with both eyes.

That is, when it is impossible to provide good stereoscopic view of displayed images through the shutter glasses (when the tilt of the shutter glasses is larger), the observer is allowed to visually recognize only one of the image for left eye and the image for right eye.

According to the above described configuration, for the observer to visually recognize the displayed image through the shutter glasses, whatever position the observer takes, the observer may not feel uncomfortable, but may visually recognize the displayed image in good condition.

In the shutter glasses of the aspect of the invention, it is preferable that a timing selection part that receives selection of one of the respective acquisition timing of the left switch signal and the right switch signal as the acquisition timing with which both the left-eye selection part and the right-eye selection part are switched to the transmission state is provided, and, when the output value is equal to or more than the threshold value, the switching operation part switches both the left-eye selection part and the right-eye selection part from the blocking state to the transmission state in response to the selected acquisition timing.

Incidentally, the image for left eye and the image for right eye are formed as images respectively seen by the observer from the left and the right for stereoscopic view of the observer because of parallax.

Therefore, for example, when the observer tilts the face toward the right, if only the image for left eye is visually recognized with both eyes, the observer may feel strange.

In the aspect of the invention, the above described timing selection part is provided in the shutter glasses, and the switching operation part operates the left-eye selection part and the right-eye selection part in the above described manner based on the selection of the acquisition timing via the timing selection part.

According to the configuration, for example, when the observer tilts the face toward the right, but visually recognizes only the image for left eye with both eyes, the observer may select the above described acquisition timing via the timing selection part for switching to visual recognition of only the image for right eye with both eyes.

Therefore, the observer may not feel strange, but may visually recognize the displayed image in better condition.

In the shutter glasses of the aspect of the invention, it is preferable that the tilt condition determination part determines a tilt direction of the shutter glasses based on the output value, and, when the output value is equal to or more than the threshold value, the switching operation part switches both the left-eye selection part and the right-eye selection part from the blocking state to the transmission state in response to the acquisition timing of a signal corresponding to the tilt direction of the left switch signal and the right switch signal.

In the aspect of the invention, the tilt condition determination part determines the tilt direction of the shutter glasses based on the output value of the tilt detection part, and the switching operation part operates the left-eye selection part and the right-eye selection part in the above described manner based on the tilt direction determined in the tilt condition determination part.

According to the configuration, for example, when the observer tilts the face toward the right, the shutter glasses automatically operate so that the observer may visually recognize only the image for right eye with both eyes and, when the observer tilts the face toward the left, the shutter glasses automatically operate so that the observer may visually recognize only the image for left eye with both eyes.

Therefore, the observer may not feel strange, but may visually recognize the displayed image in better condition.

Another aspect of the invention is directed to an image display system including an image display device of alternately displaying an image for left eye and an image for right eye, and the above described shutter glasses, wherein the image display device includes a display unit that displays images, a signal output unit that respectively outputs a left switch signal and a right switch signal in synchronization with respective display timing of the image for left eye and the image for right eye by the display unit, respectively, to the shutter glasses and a control unit that controls the display unit and the signal output unit.

In the aspect of the invention, since the image display system includes the above described shutter glasses, the same action and advantage as those of the above described shutter glasses may be enjoyed.

In the image display system according to the aspect of the invention, it is preferable that the signal output unit respectively outputs the left switch signal and the right switch signal as linearly-polarized light, the signal acquisition part includes plural light receiving parts that receive the left switch signal and the right switch signal, the plural light receiving parts respectively receive only respective linearly-polarized components having different polarization directions from each other, and the tilt detection part detects the tilt condition of the shutter glasses based on the left switch signal and the right switch signal respectively received by the plural light receiving parts.

In the aspect of the invention, the above described linearly-polarized light is used for transmission and reception of the signals in the signal output unit and the signal acquisition part. That is, the respective output values of the plural light receiving parts forming the signal acquisition part are different in response to the tilt of the shutter glasses, and thus, the tilt condition of the shutter glasses may be detected based on the relationship between the respective output values.

Therefore, the tilt condition of the shutter glasses may be simply detected without using a gyro sensor, an acceleration sensor, or the like as the tilt detection part.

Still another aspect of the invention is directed to an image display system including an image display device of alternately displaying an image for left eye and an image for right eye, and shutter glasses including a left-eye selection part and a right-eye selection part that alternately switch between a transmission state of transmitting light and a blocking state of blocking light, wherein the shutter glasses include a tilt detection part that detects a tilt condition of the shutter glasses, a tilt condition determination part that compares an output value of the tilt detection part and a predetermined threshold value, and a switching operation part that alternately switches the left-eye selection part and the right-eye selection part to the transmission state and the blocking state, when the output value is less than the threshold value, the switching operation part switches the left-eye selection part and the right-eye selection part between the transmission state and the blocking state so that only the left-eye selection part may be in the transmission state when the image display device displays the image for left eye and only the right-eye selection part may be in the transmission state when the image display device displays the image for right eye, and, when the output value is equal to or more than the threshold value, the switching operation part switches the left-eye selection part and the right-eye selection part between the transmission state and the blocking state so that both the left-eye selection part and the right-eye selection part may be in the transmission state only when the image display device displays the image for left eye or when the image display device displays the image for right eye.

In the aspect of the invention, the image display system includes the shutter glasses that can switch both the left-eye selection part and the right-eye selection part to the transmission state when one of the image for left eye and the image for right eye is displayed and can switch both the left-eye selection part and the right-eye selection part to the blocking state when the other image is displayed, and thus, the same action and advantage as those of the above described shutter glasses may be enjoyed.

### BRIEF DESCRIPTION OF THE DRAWINGS

The invention will be described with reference to the accompanying drawings, wherein like numbers reference like elements.

FIG. 1 is a perspective view showing a usage of an image display system in the first embodiment.

FIG. 2 is a block diagram showing a configuration of a display device in the first embodiment.

FIG. 3 is a block diagram showing a configuration of shutter glasses in the first embodiment.

FIGS. 4A and 4B are diagrams for explanation of output signals of a tilt condition determination part in the first embodiment.

FIGS. 5A to 5I are diagrams for explanation of an operation of the image display system in the first embodiment.

FIG. 6 is a block diagram showing a configuration of shutter glasses in the second embodiment.

FIGS. 7A to 7K are diagrams for explanation of an operation of an image display system in the second embodiment.

FIG. 8 is a block diagram showing a configuration of shutter glasses in the third embodiment.

FIG. 9 is a block diagram showing a configuration of a tilt condition determination part in the third embodiment.

FIGS. 10A to 10C are diagrams for explanation of output signals of the tilt condition determination part in the third embodiment.

FIG. 11 schematically shows a configuration of a light emitting unit in the fourth embodiment.

FIG. 12 is a block diagram showing a configuration of shutter glasses in the fourth embodiment.

FIG. 13 schematically shows a configuration of a light receiving part in the fourth embodiment.

FIG. 14 is a block diagram showing a configuration of a tilt detection part in the fourth embodiment.

FIGS. 15A to 15D show output values of respective light receiving parts, output values of the tilt detection part, and output signals of a tilt condition determination part in the fourth embodiment.

FIG. 16 is a perspective view showing a usage of an image display system in the fifth embodiment.

### DESCRIPTION OF EXEMPLARY EMBODIMENTS

### First Embodiment

As below, the first embodiment of the invention will be explained with reference to the drawings.

### Configuration of Image Display System

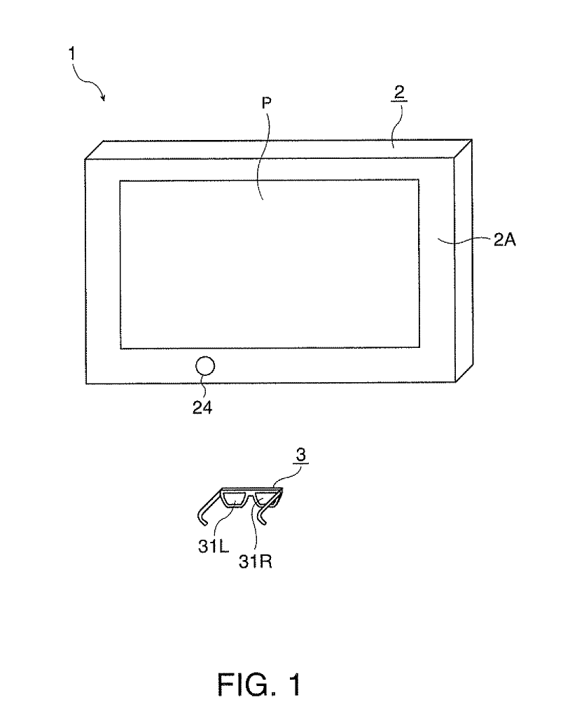

FIG. 1 is a perspective view showing a usage of an image display system 1.

The image display system 1 allows an observer to stereoscopically view displayed images, and includes a display device 2 as an image display device and shutter glasses 3 as shown in FIG. 1.

### Configuration of Display Device

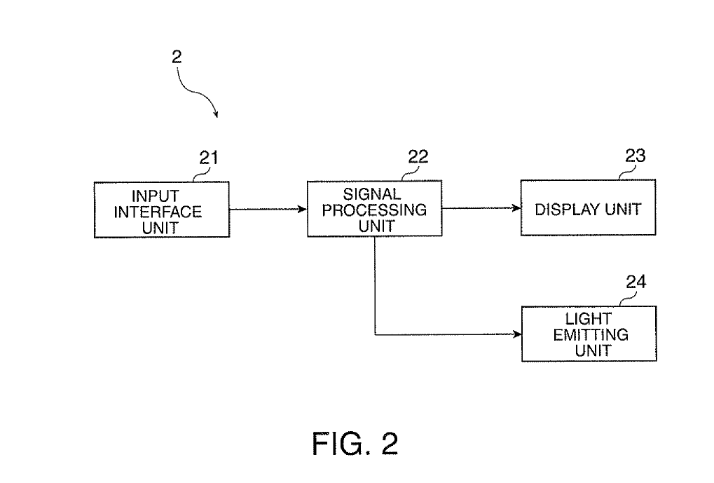

FIG. 2 is a block diagram showing a configuration of the display device 2.

The display device 2 displays images on a screen P (FIG. 1).

The display device 2 includes an input interface unit 21, a signal processing unit 22 as a control unit, a display unit 23, and a light emitting unit 24 as a signal output unit as shown in FIG. 2.

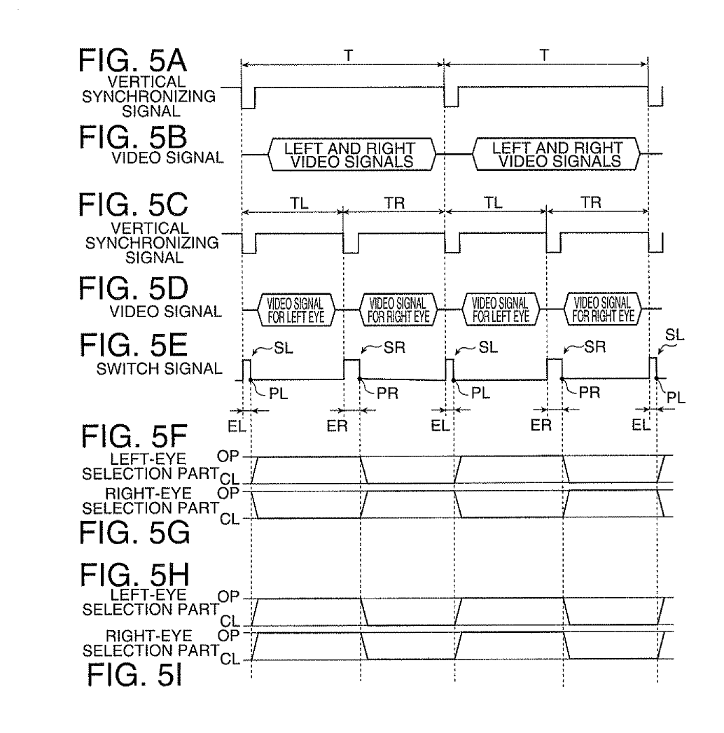

The signal processing unit 22 converts input signals externally input via the input interface unit 21 (FIGS. 5A and 5B) into predetermined signals and outputs them to the display unit 23 for time-divisional and alternate display of images for left eye and images for right eye on the display unit 23.

Further, the signal processing unit 22 outputs a first switch signal to the light emitting unit 24 in response to the display of the image for left eye on the display unit 23 (for example, the display timing of the image for left eye by the display unit 23 and the switching timing from a blocking state to a transmission state of a left-eye selection part 31L are synchronized).

Furthermore, the signal processing unit 22 outputs a second switch signal to the light emitting unit 24 in response to the display of the image for right eye on the display unit 23 (for example, the display timing of the image for right eye by the display unit 23 and the switching timing from the blocking state to the transmission state of a right-eye selection part 31R are synchronized).

The display unit 23 includes a liquid crystal display, a plasma television, an organic EL (Electro Luminescence) display, or the like and time-divisionally and alternately displays the images for left eye and the images for right eye based on the signals output from the signal processing unit 22.

The light emitting unit 24 is provided nearly at the center in the lower part seen from the front of an exterior casing 2A of the display device 2 as shown in FIG. 1.

Further, though not specifically shown, the light emitting unit 24 includes an infrared light emitting LED, a drive circuit that allows the infrared light emitting LED to emit light, etc., and outputs infrared light in response to each switch signal from the signal processing unit 22.

Note that, in the following description, for convenience of explanation, the infrared light (infrared signal) output from the light emitting unit 24 in response to the first switch signal from the signal processing unit 22 is referred to as “left switch signal” and the infrared light output from the light emitting unit 24 in response to the second switch signal from the signal processing unit 22 is referred to as “right switch signal”.

### Configuration of Shutter Glasses

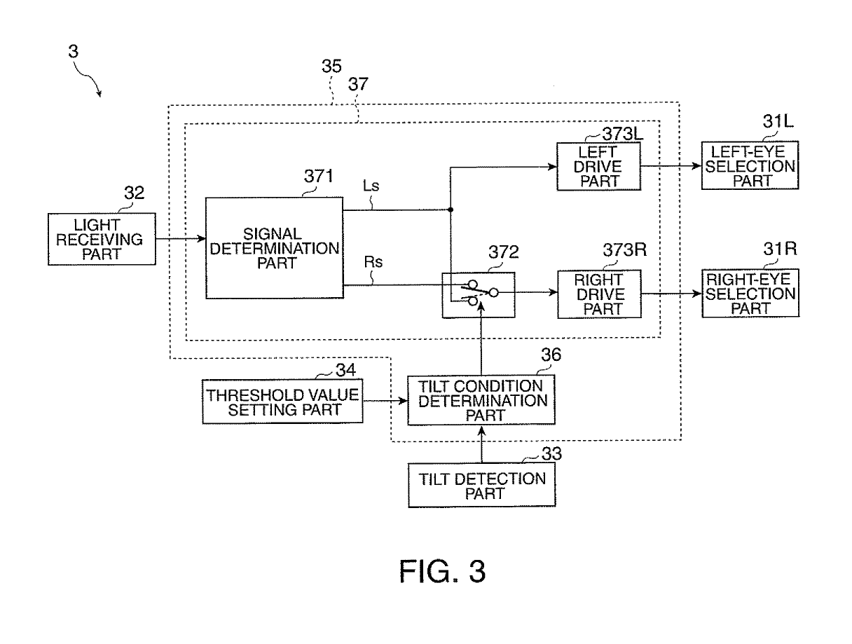

FIG. 3 is a block diagram showing a configuration of the shutter glasses 3.

The shutter glasses 3 are worn by an observer and, as shown in FIG. 1 or 3, includes the left-eye selection part 31L and the right-eye selection part 31R, a light receiving part 32 (FIG. 3) as a signal acquisitionpart, a tilt detection part 33 (FIG. 3), a threshold value setting part 34 (FIG. 3), and a shutter control part 35 (FIG. 3).

The respective selection parts 31L, 31R are provided in locations respectively corresponding to the left eye and the right eye of the observer when the observer wears the shutter glasses 3.

Further, the respective selection parts 31L, 31R include the so-called liquid crystal shutters, and respectively switch to a blocking state of blocking light and a transmission state of transmitting light in response to input of an ON-signal (application of voltage) and input of an OFF-signal (non-application of voltage).

The light receiving part 32 includes an infrared light receiving element that receives infrared light (the left switch signal and the right switch signal) etc., and receives the infrared light output from the light emitting unit 24 and outputs a signal in response to the received light to the shutter control part 35.

The tilt detection part 33 detects a tilt condition of the shutter glasses 3.

In the embodiment, though not specifically shown, the tilt detection part 33 includes a gyro sensor or an acceleration sensor, detects the tilt condition of the shutter glasses 3 (the tilt condition with respect to the condition in which the respective selection parts 31L, 31R are located in parallel to the horizontal direction), and then, outputs a signal in response to the tilt condition to the shutter control part 35.

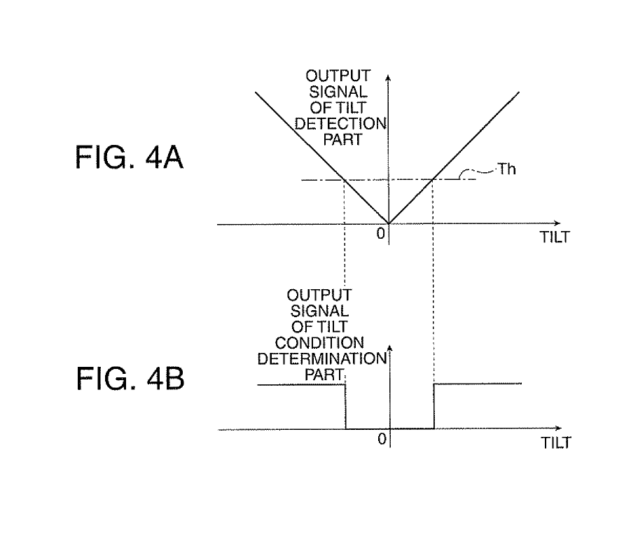

Specifically, when the tilt of the shutter glasses 3 is zero (the respective selection parts 31L, 31R are located in parallel to the horizontal direction), the tilt detection part 33 outputs a signal taking an output value of zero (see FIG. 4A). Further, the tilt detection part 33 outputs a signal taking a larger output value as the tilt of the shutter glasses 3 becomes larger (see FIG. 4A).

The threshold value setting part 34 is a part operated by a user, and receives selection of a threshold value Th (see FIG. 4A) used in a tilt condition determination part 36, which will be described later, of the shutter control part 35.

Further, the threshold value setting part 34 outputs a signal in response to the selected threshold value Th to the shutter control part 35.

The shutter control part 35 controls the respective selection parts 31L, 31R based on the output signal (tilt condition) from the tilt detection part 33, the signal from the light receiving part 32, and the threshold value Th selected via the threshold value setting part 34.

The shutter control part 35 includes the tilt condition determination part 36 and a switching operation part 37 as shown in FIG. 3.

FIGS. 4A and 4B are diagrams for explanation of output signals of the tilt condition determination part 36. Specifically, FIG. 4A is a diagram having a horizontal axis of the tilt of the shutter glasses 3 and a vertical axis of the output signal of the tilt detection part 33. FIG. 4B shows the output signal of the tilt condition determination part 36.

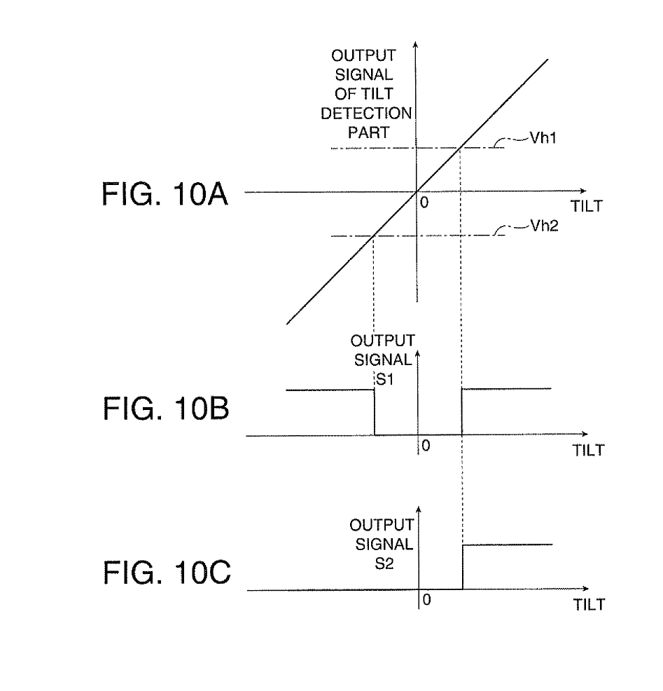

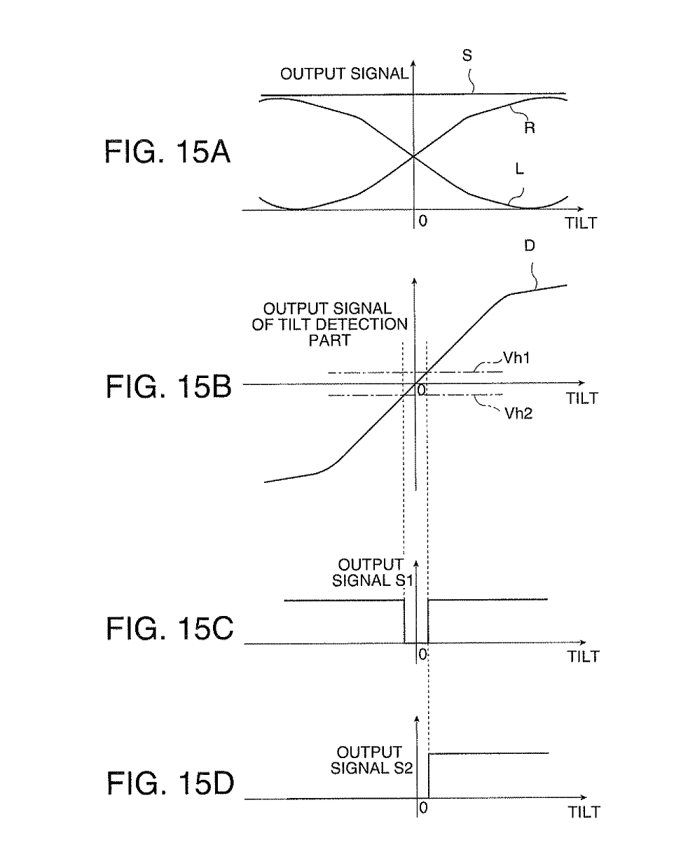

Note that, in FIGS. 4A and 4B, the origin of the horizontal axis (tilt) shows a condition in which the respective selection parts 31L, 31R are located in parallel to the horizontal direction. Further, the positive side of the horizontal axis shows a tilt toward the right such that the right-eye selection part 31R is located at the lower side and the left-eye selection part 31L is located at the upper side. Furthermore, the negative side of the horizontal axis shows a tilt toward the left such that the respective selection parts 31L, 31R are oppositely located. The same applies to FIGS. 10A to 10C and 15A to 15D, which will be described later.

The tilt condition determination part 36 compares the output value of the tilt detection part 33 and the threshold value Th selected via the threshold value setting part 34, and outputs a signal in response to the comparison result to the switching operation part 37.

Specifically, as shown in FIG. 4B, the tilt condition determination part 36 outputs a signal at the Low level when the output value of the tilt detection part 33 is less than the threshold value Th.

On the other hand, the tilt condition determination part 36 outputs a signal at the High level when the output value of the tilt detection part 33 is equal to or more than the threshold value Th.

The switching operation part 37 allows the respective selection parts 31L, 31R to operate based on the signal from the tilt condition determination part 36 and the signal from the light receiving part 32.

As shown in FIG. 3, the switching operation part 37 includes a signal determination part 371, a first signal switching part 372, and a left drive part 373L and a right drive part 373R.

The signal determination part 371 outputs a left-side signal Ls (FIG. 3) and a right-side signal Rs (FIG. 3) described as below while determining whether the signal received in the light receiving part 32 is the left switch signal or the right switch signal.

The left-side signal Ls is a signal for switching the liquid crystal shutter to the transmission state in response to the acquisition timing of the left switch signal and switching the liquid crystal shutter to the blocking state in response to the acquisition timing of the right switch signal.

The right-side signal Rs is a signal, opposite to the left side signal Ls, for switching the liquid crystal shutter to the transmission state in response to the acquisition timing of the right switch signal and switching the liquid crystal shutter to the blocking state in response to the acquisition timing of the left switch signal.

As shown in FIG. 3, the first signal switching part 372 includes a switch.

Further, when the signal at the Low level is output from the tilt condition determination part 36, the first signal switching part 372 sets a state in which the left-side signal Ls from the signal determination part 371 is output to the left drive part 373L and the right-side signal Rs is output to the right drive part 373R.

Furthermore, when the signal at the High level is output from the tilt condition determination part 36, the first signal switching part 372 sets a state in which the left-side signal. Ls is output to both of the respective drive parts 373L, 373R.

The respective drive parts 373L, 373R output ON-signals and OFF-signals to the respective selection parts 31L, 31R based on the left-side signal Ls and the right-side signal Rs, and respectively switch the transmission state and the blocking state of the respective selection parts 31L, 31R.

### Operation of Image Display System

FIGS. 5A to 5I are diagrams for explanation of an operation of the image display system 1. Specifically, FIGS. 5A and 5B show vertical synchronizing signals and video signals contained in the input signals externally input via the input interface unit 21, respectively. FIGS. 5C and 5D show vertical synchronizing signals and video signals converted in the signal processing unit 22, respectively. FIG. 5E shows the first and second switch signals SL, SR output from the signal processing unit 22. FIGS. 5F and 5G show the transmission states OP or the blocking states CL in the respective selection parts 31L, 31R when the tilt of the shutter glasses 3 is smaller, respectively. FIGS. 5H and 5I show the transmission states OP or the blocking states CL in the respective selection parts 31L, 31R when the tilt of the shutter glasses 3 is larger, respectively.

Next, the operation of the above described image display system 1 will be explained with reference to FIGS. 5A to 51.

Note that, in the following description, for convenience of explanation, an operation of the display device 2 and an operation of the shutter glasses 3 will be explained in turn as the operation of the image display system 1.

### Operation of Display Device

In the embodiment, the externally input signals include the vertical synchronizing signals at a frequency of 60 Hz (FIG. 5A) and the left and right video signals containing the left-eye video signals and right-eye video signals for one frame with respect to each vertical scan period T ( 1/60 (sec)) (FIG. 5B).

As shown in FIG. 5C, the signal processing unit 22 converts the vertical synchronizing signal into a vertical synchronizing signal at a doubled frequency of 120 Hz with respect to the input signals input via the input interface unit 21. Further, as shown in FIG. 5D, the signal processing unit 22 outputs the left-eye video signals contained in the left and right video signals in the vertical scan periods TL and outputs the right-eye video signals contained in the left and right video signals in the vertical scan periods TR of the alternately repeated vertical scan periods TL, TR ( 1/120 (sec)) of the converted vertical synchronizing signals.

Then, the display unit 23 displays the left-eye images based on the left-eye video signals on the screen P in the vertical scan periods TL and displays the right-eye images based on the right-eye video signals on the screen P in the vertical scan periods TR based on the signals output from the signal processing unit 22.

Further, as shown in FIG. 5E, the signal processing unit 22 outputs the first switch signals SL to the light emitting unit 24 according to the start times of the vertical scan periods TL and outputs the second switch signals SR to the light emitting unit 24 according to the start times of the vertical scan periods TR.

Then, the light emitting unit 24 emits light response to the respective switch signals SL, SR and outputs (sends) the left switch signals and the right switch signals.

Note that, in the embodiment, the respective switch signals SL, SR have different signal widths (pulse widths) as shown in FIG. 5E (the signal width of the first switch signal SL is smaller than the signal width of the second switch signal SR). That is, the light emitting unit 24 emits light and outputs the left switch signals in the predetermined periods EL (FIG. 5E) from the start times of the vertical scan periods TL, and emits light and outputs the right switch signals in the predetermined periods ER (FIG. 5E) longer than the predetermined periods EL from the start times of the vertical scan periods TR.

### Operation of Shutter Glasses

The light receiving part 32 receives infrared light (the left switch signals and the right switch signals) from the light emitting unit 24.

As described above, the light emission times of the light emitting unit 24 are different in response to the respective switch signals SL, SR. Accordingly, the signals output from the light receiving part 32 have different signal widths according to the light emission times of the light emitting unit 24 (according to the signal widths of the respective switch signals SL, SR).

Then, the signal determination part 371 outputs the left-side signals Ls and the right-side signals Rs while determining whether the signal received in the light receiving part 32 is the left switch signal or the right switch signal by recognizing the signal width of the signal from the light receiving part 32.

Further, the first signal switching part 372 changes the output destination of the left-side signal Ls and the right-side signal Rs based on the signal from the tilt condition determination part 36 (the signal at the Low level when the tilt of the shutter glasses 3 is smaller and the signal at the High level when the tilt of the shutter glasses 3 is larger).

As below, for convenience of explanation, the case where the tilt of the shutter glasses 3 is smaller and the case where the tilt of the shutter glasses 3 is larger will be separately explained in turn.

### Operation for Smaller Tilt of Shutter Glasses

When the tilt of the shutter glasses 3 is smaller (when the signal at the Low level is output from the tilt condition determination part 36), the first signal switching part 372 is as shown by a solid line in FIG. 3.

That is, the first signal switching part 372 sets a state such that the left-side signal Ls is output to the left drive part 373L and the right-side signal Rs is output to the right drive part 373R.

Then, as shown in FIG. 5F, the left drive part 373L outputs the OFF-signal to the left-eye selection part 31L for starting switching to the transmission state OP to switch the left-eye selection part 31L to the transmission state OP based on the left-side signal Ls from the signal determination part 371 in response to the acquisition timing of the left switch signal by the light receiving part 32 (at the output completion times PL of the first switch signals SL).

Further, as shown in FIG. 5F, the left drive part 373L outputs the ON-signal to the left-eye selection part 31L for starting switching to the blocking state CL to switch the left-eye selection part 31L to the blocking state CL in response to the acquisition timing of the right switch signal by the light receiving part 32 (at the output completion times PR of the second switch signals SR).

On the other hand, as shown in FIG. 5G, the right drive part 373R outputs the ON-signal to the right-eye selection part 31R for starting switching to the blocking state CL to switch the right-eye selection part 31R to the blocking state CL based on the right-side signal Rs from the signal determination part 371 in response to the acquisition timing of the left switch signal by the light receiving part 32 (at the output completion times PL).

Further, as shown in FIG. 5G, the right drive part 373R outputs the OFF-signal to the right-eye selection part 31R for starting switching to the transmission state OP to switch the right-eye selection part 31R to the transmission state OP in response to the acquisition timing of the right switch signal by the light receiving part 32 (at the output completion times PR).

That is, the right drive part 373R switches the respective states OP, CL of the right-eye selection part 31R to the opposite state to the respective states OP, CL of the left-eye selection part 31L based on the right-side signal Rs from the signal determination part 371.

Through the above described operation, when the image for left eye is displayed on the screen P, only the left-eye selection part 31L is in the transmission state OP. Accordingly, the image for left eye on the screen P is visually recognized with the left eye only of the observer through the shutter glasses 3.

Further, when the image for right eye is displayed on the screen P, only the right-eye selection part 31R is in the transmission state OP. Accordingly, the image for right eye on the screen P is visually recognized with the right eye only of the observer through the shutter glasses 3.

Therefore, the observer stereoscopically views the displayed images (the image for left eye, the image for right eye) on the screen P because of parallax.

### Operation for Larger Tilt of Shutter Glasses

When the tilt of the shutter glasses 3 is larger (when the signal at the High level is output from the tilt condition determination part 36), the first signal switching part 372 is as shown by a dashed-two dotted line in FIG. 3.

That is, the first signal switching part 372 sets a state such that the left-side signal Ls is output to both of the respective drive parts 373L, 373R.

Then, as shown in FIGS. 5H and 5I, the respective drive parts 373L, 373R allow the respective selection parts 31L, 31R to operate like the above described operation (FIG. 5F) of the left-eye selection part 31L when the tilt of the shutter glasses 3 is smaller based on the left-side signal Ls from the signal determination part 371.

Through the operation, both of the respective selection parts 31L, 31R are in the transmission state OP only when the image for left eye is displayed on the screen P, and thus, the observer visually recognize only the image for left eye on the screen P with both eyes.

According to the above described first embodiment, there is the following advantage.

In the embodiment, since the shutter glasses 3 include the tilt detection part 33, the light receiving part 32, the tilt condition determination part 36, and the switching operation part 37, when the tilt of the shutter glasses 3 is smaller, the observer may stereoscopically view the displayed images (the image for left eye and the image for right eye) through the shutter glasses 3. Further, when the tilt of the shutter glasses 3 is larger, the observer may visually recognize only the image for left eye with both eyes through the shutter glasses 3.

Therefore, for the observer to visually recognize the displayed image through the shutter glasses 3, whatever position the observer takes, the observer may not feel uncomfortable, but may visually recognize the displayed image in good condition.

Further, since the threshold value setting part 34 is provided in the shutter glasses 3, the observer may select the threshold value Th (corresponding to the tilt angle of the shutter glasses 3) when the observer visually recognize only the image for left eye with both eyes through the shutter glasses 3.

Therefore, the shutter glasses 3 may be operated according to the observer's preference, and the convenience may be improved.

### Second Embodiment

Next, the second embodiment of the invention will be explained with reference to the drawings.

In the following explanation, the same signs are assigned to the similar configuration and the same members as those of the first embodiment, and their detailed explanation will be omitted or simplified.

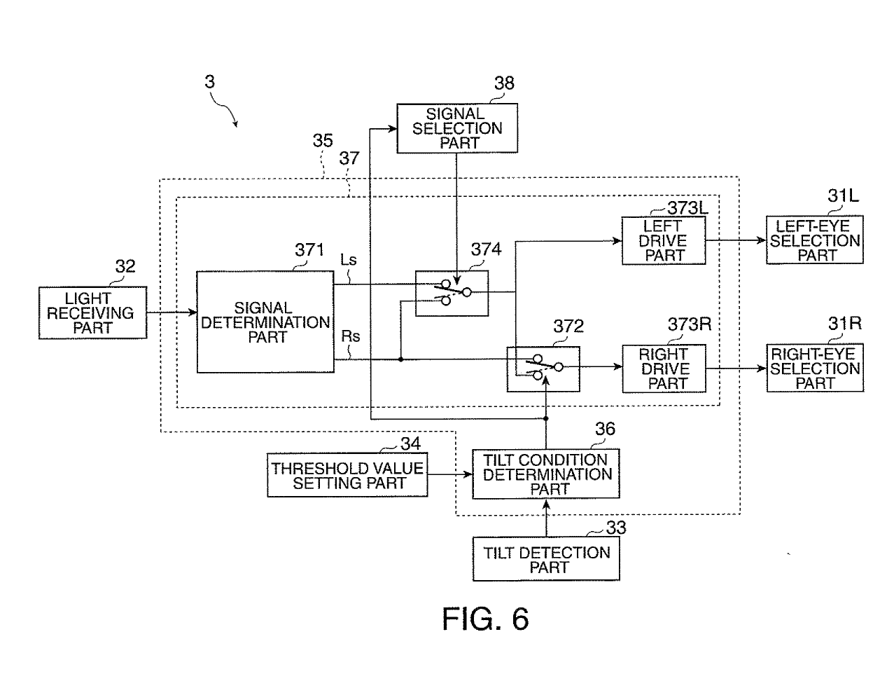

FIG. 6 is a block diagram showing a configuration of shutter glasses 3 in the second embodiment.

The embodiment is different only in the configuration of the shutter glasses 3 from the first embodiment as shown in FIG. 6.

Specifically, the shutter glasses 3 in the second embodiment is formed by adding a signal selection part 38 as a timing selection part and a second signal switching part 374 to the first embodiment as shown in FIG. 6.

The rest of the configuration is the same as that of the first embodiment.

The signal selection part 38 is a part operated by a user and receives selection such that the respective selection parts 31L, 31R are operated based on the left-side signal Ls or the right-side signal Rs when the tilt of the shutter glasses 3 is larger.

In other words, the signal selection part 38 receives one selection of the respective acquisition timing of the left switch signal and the right switch signal by the light receiving part 32 as the acquisition timing with which both of the respective selection parts 31L, 31R are switched to the transmission state OP.

Then, the signal selection part 38 outputs a signal to the shutter control part 35 in response to the selection when the tilt of the shutter glasses 3 is larger (when the signal at the High level is output from the tilt condition determination part 36).

The second signal switching part 374 includes a switch as shown in FIG. 6.

Further, the second signal switching part 374 sets a state such that the left-side signal Ls is output to both of the respective drive parts 373L, 3738 together with the first signal switching part 372 when the selection of the operation based on the left-side signal Ls via the signal selection part 38 (hereinafter, referred to as “selection of the left-side signal Ls) is performed and the signal at the High level is output from the tilt condition determination part 36.

Furthermore, the second signal switching part 374 sets a state such that the right-side signal Rs is output to both of the respective drive parts 373L, 373R together with the first signal switching part 372 when the selection of the operation based on the right-side signal Rs via the signal selection part 38 (hereinafter, referred to as “selection of the right-side signal Rs) is performed and the signal at the High level is output from the tilt condition determination part 36.

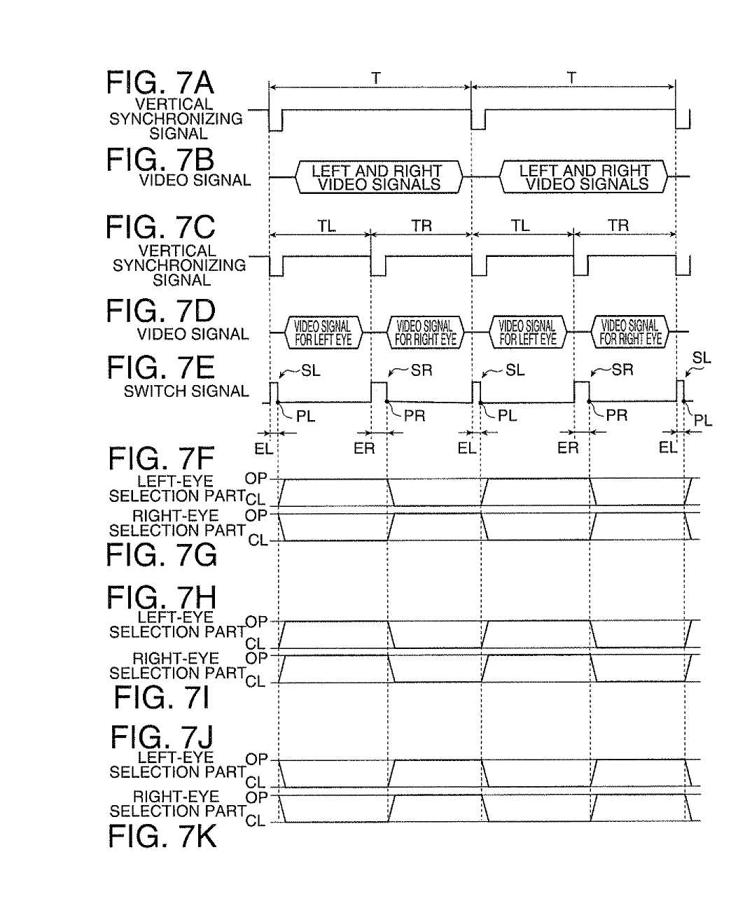

FIGS. 7A to 7K are diagrams for explanation of an operation of an image display system 1 in the second embodiment. Specifically, FIGS. 7A to 7G are the same as FIGS. 5A to 5G. FIGS. 7H to 7I respectively show transmission states OP or blocking states CL in the respective selection parts 31L, 31R when the tilt of the shutter glasses 3 is larger and the left-side signal Ls is selected in the signal selection part 38. FIGS. 7J and 7K show transmission states OP or blocking states CL in the respective selection parts 31L, 31R when the tilt of the shutter glasses 3 is larger and the right-side signal Rs is selected in the signal selection part 38.

When the tilt of the shutter glasses 3 is larger and the left-side signal Ls is selected in the signal selection part 38, the first signal switching part 372 is as shown by a dashed-two dotted line in FIG. 6 and the second signal switching part 374 is as shown by a solid line in FIG. 6.

That is, the respective signal switching parts 372, 374 set a state such that the left-side signal Ls is output to both of the respective drive parts 373L, 373R.

Therefore, as shown in FIGS. 7H and 7I, the respective drive parts 373L, 373R allow the respective selection parts 31L, 31R to operate like the operation (FIGS. 5H and 5I) when the tilt of the shutter glasses 3 is larger explained in the first embodiment based on the left-side signal Ls from the signal determination part 371.

On the other hand, when the tilt of the shutter glasses 3 is larger and the right-side signal Rs is selected in the signal selection part 38, the first signal switching part 372 is as shown by a solid line in FIG. 6 and the second signal switching part 374 is as shown by a dashed-two dotted line in FIG. 6.

That is, the respective signal switching parts 372, 374 set a state such that the right-side signal Rs is output to both of the respective drive parts 373L, 373R.

Then, as shown in FIGS. 7J and 7K, the respective drive parts 373L, 373R allow the respective selection parts 31L, 31R to operate like the operation of the right-eye selection part 31R (FIG. 7G) when the tilt of the shutter glasses 3 is smaller based on the right-side signal Rs from the signal determination part 371.

Through the above described operation, since both of the respective selection parts 31L, 31R are in the transmission states OP only when the image for right eye is displayed on the screen P, the observer may visually recognize only the image for right eye on the screen P with both eyes.

According to the above described second embodiment, there is the following advantage in addition to the advantage of the first embodiment.

In the embodiment, since the signal selection part 38 is provided in the shutter glasses 3 and the switching operation part 37 operates the respective selection parts 31L, 31R based on the selection via the signal selection part 38.

Accordingly, for example, when the observer tilts the face toward the right, but visually recognizes only the image for left eye with both eyes, switching to visual recognition of only the image for right eye with both eyes may be realized by selecting the right-side signal Rs via the signal selection part 38.

Therefore, the observer may not feel strange, but may visually recognize the displayed image in better condition.

### Third Embodiment

Next, the third embodiment of the invention will be explained with reference to the drawings.

In the following explanation, the same signs are assigned to the similar configuration and the same members as those of the second embodiment, and their detailed explanation will be omitted or simplified.

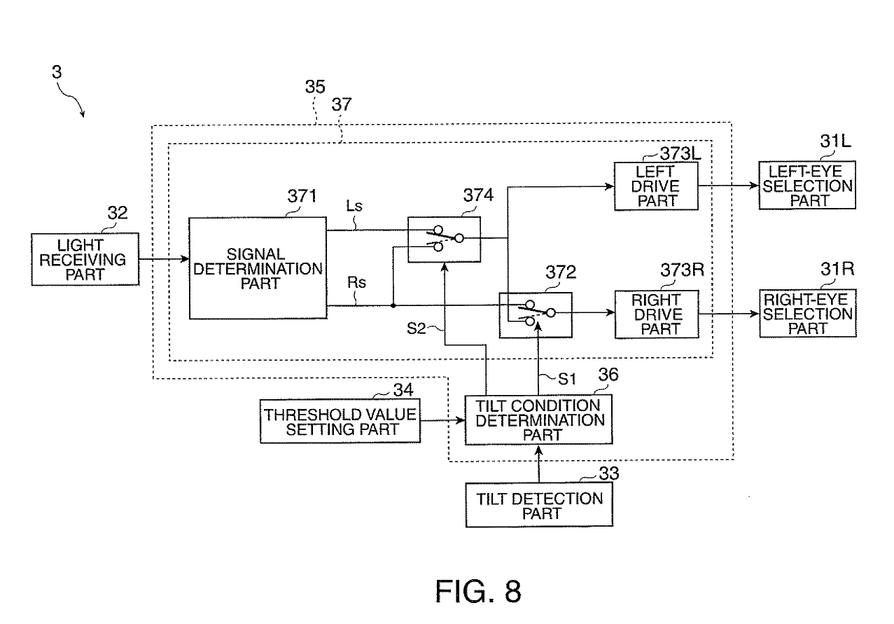

FIG. 8 is a block diagram showing a configuration of shutter glasses 3 in the third embodiment.

The embodiment is different only in the configuration of the shutter glasses 3 from the second embodiment as shown in FIG. 8.

Specifically, the shutter glasses 3 in the third embodiment are different from those of the second embodiment only in that the signal selection part 38 is omitted and the second signal switching part 374 operates based on an output signal S2 from the tilt condition determination part 36 as shown in FIG. 8. The rest of the configuration is the same as that of the second embodiment.

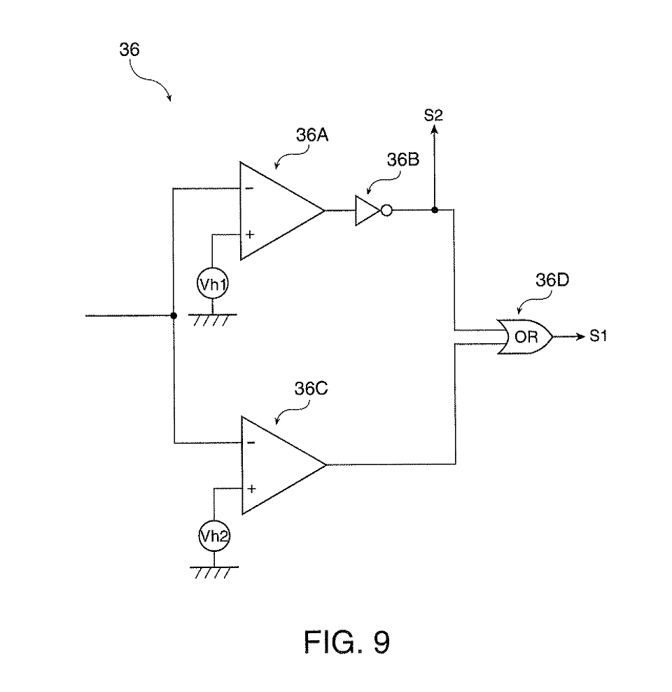

FIG. 9 is a block diagram showing a configuration of the tilt condition determination part 36 in the third embodiment.

FIGS. 10A to 10C are diagrams for explanation of output signals S1, S2 of the tilt condition determination part 36. Specifically, FIG. 10A shows an output signal of the tilt detection part 33 with respect to the tilt of the shutter glasses 3, and FIGS. 10B and 10C respectively show the output signals S1, S2 of the tilt condition determination part 36 with respect to the tilt of the shutter glasses 3.

As shown in FIG. 10A, the tilt detection part 33 in the third embodiment outputs a signal having an output value of zero when the tilt of the shutter glasses 3 is zero. Further, the tilt detection part 33 outputs a signal having a positive output value when the shutter glasses 3 tilt toward the right and outputs a signal having a negative output value when the shutter glasses 3 tilt toward the left.

Note that the tilt detection part 33 outputs a signal having an output value with a larger absolute value as the tilt of the shutter glasses 3 is larger.

As shown in FIG. 9, the tilt condition determination part 36 in the third embodiment includes a first comparator 36A that compares the output value of the tilt detection part 33 and a first threshold value Vh1, a NOT circuit 36B, a second comparator 36C that compares the output value of the tilt detection part 33 and a second threshold value Vh2, and an OR circuit 36D.

Note that the first threshold value Vh1 is a positive value like the threshold value Th explained in the first embodiment.

Further, the second threshold value Vh2 is a negative value having the same absolute value as that of the first threshold value Vh1.

These respective threshold values Vh1, Vh2 are arranged so that predetermined values may be selectable via the threshold value setting part 34 as is the case of the first embodiment.

Further, a signal via the first comparator 36A and the NOT circuit 36B and a signal via the second comparator 36C are input to the OR circuit 36D, and the tilt condition determination part 36 outputs a signal output from the OR circuit 36D as the output signal S1.

Furthermore, the tilt condition determination part 36 outputs a signal via the first comparator 36A and the NOT circuit 36B as the output signal 52.

Specifically, when the output value of the tilt detection part 33 is less than the first threshold value Vh1, the first comparator 36A outputs a signal at the High level. Therefore, the output signal S2 in this case is a signal at the Low level via the NOT circuit 36B as shown in FIG. 10C.

On the other hand, when the output value of the tilt detection part 33 is equal to or more than the first threshold value Vh1, the first comparator 36A outputs a signal at the Low level. Therefore, the output signal S2 in this case is a signal at the High level via the NOT circuit 36B as shown in FIG. 10C.

Further, when the output value of the tilt detection part 33 is less than the second threshold value Vh2, the second comparator 36C outputs a signal at the High level. Therefore, the output signal S1 in this case is a signal at the High level via the OR circuit 36D as shown in FIG. 10B because the signal at the Low level is output from the NOT circuit 36B (FIG. 10C) and the signal at the High level is output from the second comparator 36C.

On the other hand, when the output value of the tilt detection part 33 is equal to or more than the second threshold value Vh2, the second comparator 36C outputs a signal at the Low level.

That is, the output signal S1 when the output value of the tilt detection part 33 is between the first threshold value Vh1 and the second threshold value Vh2 is a signal at the Low level via the OR circuit 36D as shown in FIG. 10B because the signal at the Low level is output from the NOT circuit 36B (FIG. 10C) and the signal at the Low level is also output from the second comparator 36C.

Further, the output signal S1 when the output value of the tilt detection part 33 is equal to or more than the first threshold value Vh1 is a signal at the High level via the OR circuit 36D as shown in FIG. 10B because the signal at the High level is output from the NOT circuit 36B (FIG. 10C) and the signal at the Low level is output from the second comparator 36C.

Then, the output signal S1 from the tilt condition determination part 36 is input to the first signal switching part 372 as shown in FIG. 8.

Note that, as described above, the output signal S1 is the same as the signal output from the tilt condition determination part 36 to the first signal switching part 372 that has been explained in the first embodiment.

Therefore, also, in the third embodiment, the first signal switching part 372 operates like that in the first embodiment.

Further, the output signal S2 from the tilt condition determination part 36 is input to the second signal switching part 374 as shown in FIG. 8.

Then, the second signal switching part 374 is as shown by a dashed-two dotted line in FIG. 8 (the respective selection parts 31L, 31R operate as shown in FIGS. 7J and 7K) when the output signal S2 is the signal at the High level (when the shutter glasses 3 largely tilt toward the right).

Furthermore, the second signal switching part 374 is as shown by a solid line in FIG. 8 (the respective selection parts 31L, 31R operate as shown in FIGS. 7H and 7I) when the output signal S2 is the signal at the Low level (when the shutter glasses 3 does not so much tilt or largely tilt toward the left).

According to the above described third embodiment, there is an advantage in addition to the same advantage as that of the first embodiment.

In the embodiment, the tilt condition determination part 36 determines the tilt direction of the shutter glasses 3 based on the output value of the tilt detection part 33 and outputs the output signal S2, and the switching operation part 37 operates the respective selection parts 31L, 31R based on the output signal 82.

According to the configuration, for example, when the observer tilts the face toward the right, the shutter glasses automatically operate so that the observer may visually recognize only the image for right eye with both eyes and, when the observer tilts the face toward the left, the shutter glasses automatically operate so that the observer may visually recognize only the image for left eye with both eyes.

Therefore, the observer may not feel strange, but may visually recognize the displayed image in better condition.

### Fourth Embodiment

Next, the fourth embodiment of the invention will be explained with reference to the drawings.

In the following explanation, the same signs are assigned to the similar configuration and the same members as those of the third embodiment, and their detailed explanation will be omitted or simplified.

The embodiment is different only in the detection structure of the tilt condition of the shutter glasses 3 from the third embodiment. The rest of the configuration is the same as that of the third embodiment.

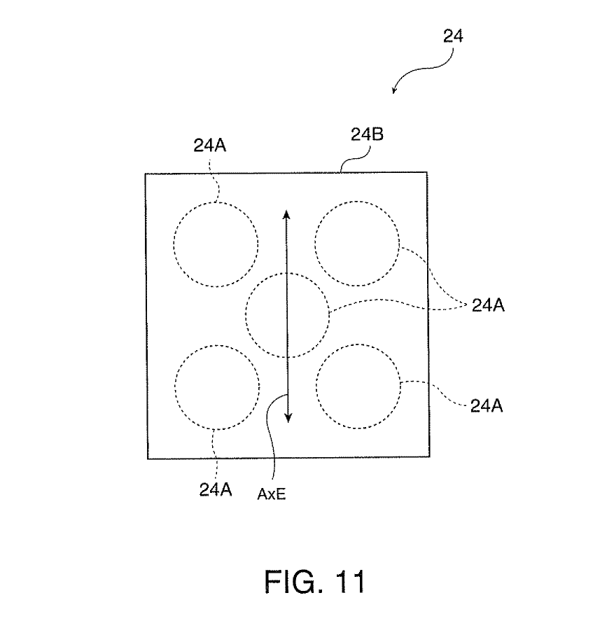

FIG. 11 schematically shows a configuration of a light emitting unit 24 in the fourth embodiment.

As shown in FIG. 11, the light emitting unit 24 in the fourth embodiment includes plural infrared light emitting LEDs 24A, a drive circuit (not shown) that allows the infrared light emitting LEDs 24A to emit light, and a polarizer 24B provided on the front side (observer's side) of the respective infrared light emitting LEDs 24A.

The polarizer 24B has a polarization axis AxE along the vertical direction (FIG. 11), and transmits only a linearly-polarized component in the polarization direction along the polarization axis AxE of the infrared light (the left switch signal and the right switch signal) output from the respective infrared light emitting LEDs 24A.

That is, the light emitting unit 24 outputs the left switch signal and the right switch signal having the linearly-polarized components along the polarization axis AxE.

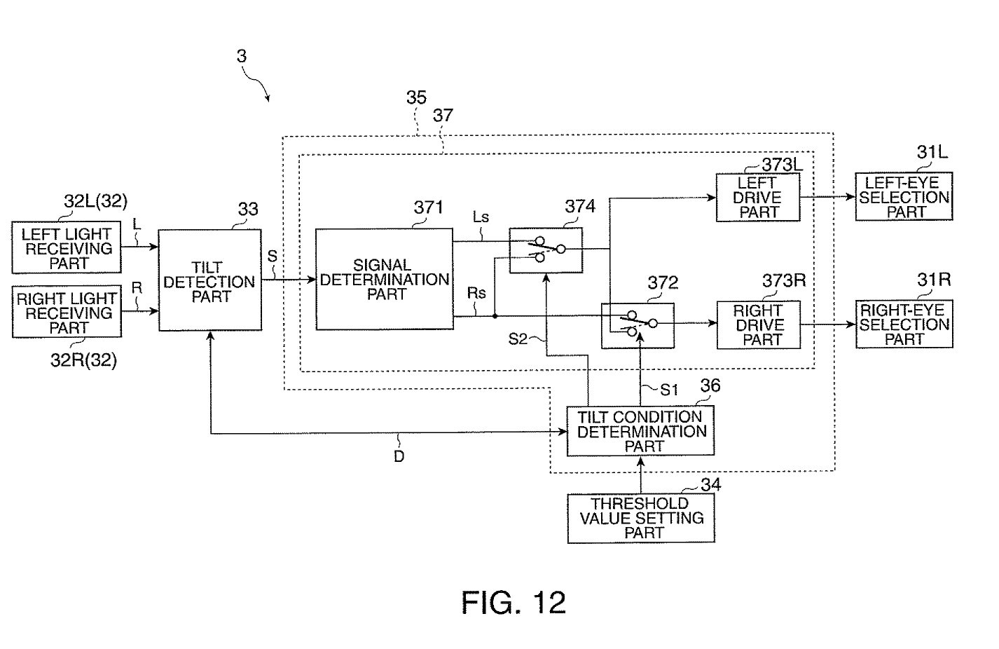

FIG. 12 is a block diagram showing a configuration of the shutter glasses 3 in the fourth embodiment.

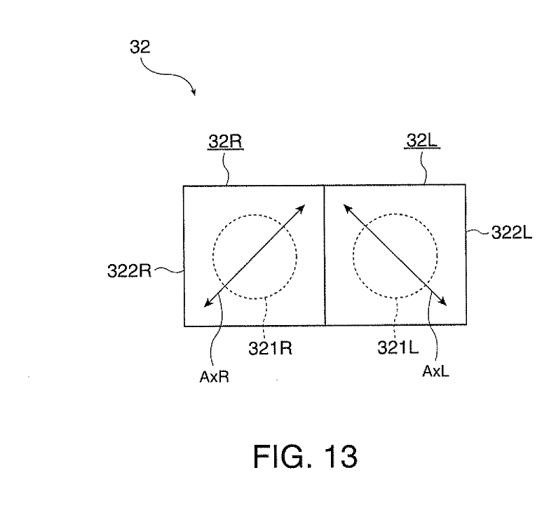

FIG. 13 schematically shows a configuration of the light receiving part 32 in the fourth embodiment.

In the shutter glasses 3 in the fourth embodiment, as shown in FIGS. 12 and 13, the light receiving part 32 includes two of a left light receiving part 32L and a right light receiving part 32R, and the tilt detection part 33 detects the tilt condition of the shutter glasses 3 based on the signals from the respective light receiving parts 32L, 32R.

As shown in FIG. 13, the left light receiving part 32L includes an infrared light receiving element 321L and a polarizer 322L provided on the front side (on the side facing the display device 2) of the infrared light receiving element 321L.

The polarizer 322L has a polarization axis AxL tilted to nearly 45° relative to the vertical direction (tilted closer to the vertical direction when the shutter glasses 3 tilt toward the left), and transmits only the linearly-polarized component in the polarization direction along the polarization axis AxL of the incident infrared light (the left switch signal and the right switch signal).

As shown in FIG. 13, the right light receiving part 32R includes an infrared light receiving element 321R and a polarizer 322R having the same configurations as those of the infrared light receiving element 321L and the polarizer 322L of the left light receiving part 32L.

Note that, as shown in FIG. 13, the polarization axis AxR of the polarizer 322R is orthogonal to the polarization axis AxL of the polarizer 322L and tilted closer to the vertical direction when the shutter glasses 3 tilt toward the right.

Therefore, when the tilt of the shutter glasses 3 is zero, output values L, R of the respective light receiving parts 32L, 32R by the reception of the left switch signal and the right switch signal are the same (see FIG. 15A).

Further, when the shutter glasses 3 tilt toward the left, the output value L of the left light receiving part 32L becomes larger and the output value R of the right light receiving part 32R becomes smaller.

On the other hand, when the shutter glasses 3 tilt toward the right, the output value R of the right light receiving part 32R becomes larger and the output value L of the left light receiving part 32L becomes smaller.

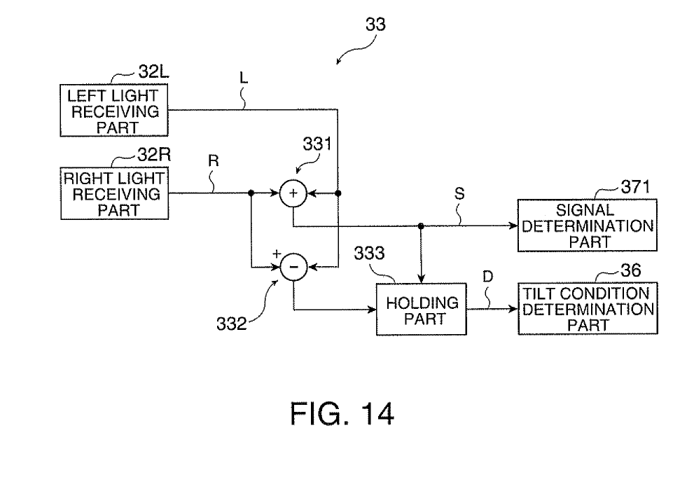

FIG. 14 is a block diagram showing a configuration of a tilt determination part 33 in the fourth embodiment.

FIGS. 15A to 15D show output values L, R of the respective light receiving parts 32L, 32R, output values S, D of the tilt detection part 33, and output signals S1, S2 of the tilt condition determination part 36 in the fourth embodiment. Specifically, FIG. 15A shows the output values L, R of the respective light receiving parts 32L, 32R and the output value S of the tilt detection part 33 with respect to the tilt of the shutter glasses 3, FIG. 15B shows the output value D of the tilt detection part 33 with respect to the tilt of the shutter glasses 3, FIGS. 15C and 15D show the output signals S1, S2 of the tilt condition determination part 36 with respect to the tilt of the shutter glasses 3.

As shown in FIG. 14, the tilt detection part 33 in the fourth embodiment includes an adder circuit 331 of adding the output value L of the left light receiving part 32L and the output value R of the right light receiving part 32R, and a difference circuit 332 of obtaining a difference between the output value R and the output value L.

The output value S (the sum of the output values L, R) of the adder circuit 331 is input to the signal determination part 371 as shown in FIG. 14.

Note that the output value S is the same as the output value by the reception of the left switch signal and the right switch signal of the light receiving part 32 explained in the third embodiment.

Therefore, also, in the fourth embodiment, the signal determination part 371 may perform the same determination as that of the first embodiment.

The output of the difference circuit 332 is input to the tilt condition determination part 36 as the output value D (the difference between the output values R, L) via a holding part 333 as shown in FIG. 14. The holding part 333 updates and holds the output value of the difference circuit 332 when the output S of the adder circuit 331 is output, and the received infrared light is discrete, but the output value D may be output as a stable continuous value.

Note that the output value D is the same as the output value of the tilt detection part 33 explained in the third embodiment as shown in FIG. 15B.

Therefore, the tilt condition determination part 36 outputs the same output signals S1, S2 as those of the third embodiment as shown in FIGS. 15C and 15D.

According to the above described fourth embodiment, there is an advantage in addition to the same advantages as those of the third embodiment.

In the embodiment, the linearly polarized light is used for transmission and reception of the signals in the light emitting unit 24 and the light receiving part 32. That is, the respective output values of the respective light receiving parts 32L, 32R are different in response to the tilt of the shutter glasses 3, and thus, the tilt condition of the shutter glasses 3 may be detected based on the relationship between the respective output values.

Therefore, the tilt condition of the shutter glasses 3 may be simply detected without using a gyro sensor, an acceleration sensor, or the like as the tilt detection part 33.

### Fifth Embodiment

Next, the fifth embodiment of the invention will be explained with reference to the drawings.

In the following explanation, the same signs are assigned to the similar configuration and the same members as those of the first embodiment, and their detailed explanation will be omitted or simplified.

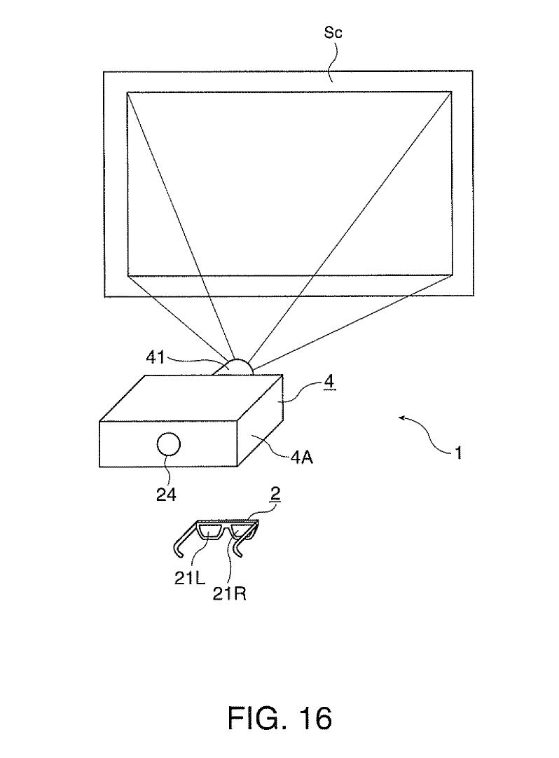

FIG. 16 shows a usage of an image display system 1 in the fifth embodiment.

In the first embodiment, the display device 2 that displays the displayed images (the image for left eye, the image for right eye) on the screen P has been employed as the image display device.

On the other hand, the fifth embodiment is different only in that a projector 4 is employed as the image display device as shown in FIG. 16.

Though the specific illustration is omitted, the projector 4 includes the same configurations 21 to 24 as those of the display device 2 that has been explained in the first embodiment.

Note that the display unit 23 in the fifth embodiment includes a light modulator such as a liquid crystal panel forming images by modulating luminous flux from a light source, and a projection lens 14 (FIG. 16).

Further, the projector 4 projects images formed in the light modulator based on the signal output from the signal processing unit 22 toward a screen Sc (FIG. 16) using the projection lens 41, and displays the projected images (the image for left eye, the image for right eye) on the screen Sc.

Further, in the embodiment, as shown in FIG. 16, the light emitting unit 24 is provided on the end surface at the rear side of an exterior casing 4A in the projector 4.

Even in the case where the projector 4 is employed as the image display device as in the above described fifth embodiment, the same action and advantage as those of the first embodiment may be enjoyed.

Note that the invention is not limited to the above described embodiments, but the invention includes modifications, improvements, etc, within the range in which the purpose of the invention may be achieved.

In the respective embodiments, the left-side signal Ls has been the signal for switching the liquid crystal shutter to the transmission state in response to the acquisition timing of the left switch signal and switching the liquid crystal shutter to the blocking state in response to the acquisition timing of the right switch signal, however, not limited to that. The left-side signal Ls may be a signal for switching the liquid crystal shutter to the transmission state in response to the acquisition timing of the left switch signal and switching it to the blocking state after a lapse of a preset period. Alternatively, the left-side signal Ls may be a signal for switching the liquid crystal shutter to the transmission state in response to the acquisition timing of the left switch signal and switching it to the blocking state in response to another signal. That is, the left-side signal Ls may be a signal for switching the transmission state and the blocking state of the liquid crystal shutter so that the liquid crystal shutter may be in the transmission state within the period in which the image for left eye is displayed and the liquid crystal shutter may be in the blocking state within the period in which the image for right eye is displayed.

Similarly, the right-side signal Rs has been the signal for switching the liquid crystal shutter to the transmission state in response to the acquisition timing of the right switch signal and switching the liquid crystal shutter to the blocking state in response to the acquisition timing of the left switch signal, however, not limited to that. The right-side signal Rs may be a signal for switching the liquid crystal shutter to the transmission state in response to the acquisition timing of the right switch signal and switching it to the blocking state after a lapse of a preset period. Alternatively, the right-side signal Rs may be a signal for switching the liquid crystal shutter to the transmission state in response to the acquisition timing of the right switch signal and switching it to the blocking state in response to another signal. That is, the right-side signal Rs may be a signal for switching the transmission state and the blocking state of the liquid crystal shutter so that the liquid crystal shutter may be in the transmission state within the period in which the image for right eye is displayed and the liquid crystal shutter may be in the blocking state within the period in which the image for left eye is displayed.

In the respective embodiments, the respective selection parts 31L, 31R have included the liquid crystal shutters, however, not limited to those. For the left-eye selection part and the right-eye selection part, another configuration such as a configuration of mechanically switching to the transmission state or the blocking state, for example, may be employed as long as the configuration switches to the transmission state OP or the blocking state CL.

In the first to third, and fifth embodiments, the light receiving part 32 and the light emitting unit 24 have performed transmission and reception of the infrared signals, however, the type of the signals is not limited to the infrared signals, but a configuration of transmitting and receiving another type of signals may be employed.

In the fourth embodiment, the polarization axes AxE, AxL, AxR are not limited to those in the directions explained in the fifth embodiment.

Further, in the fourth embodiment, the polarization axes AxL, AxR may be different polarization axes from each other, and one of them may be in the same direction as that of the polarization axis AxE.

Furthermore, in the fourth embodiment, the light receiving part 32 has included two of the respective light receiving parts 32L, 32R, however, the number is not limited to two as long as it is a plural number.

The invention may be used for an image display device such as a projector and an image display system for stereoscopic viewing of images using shutter glasses.

The entire disclosure of Japanese Patent Application No. 2011-009050, filed Jan. 19, 2011 is expressly incorporated by reference herein.

What is claimed is:

1. Shutter glasses used for an image display system having an image display device of alternately displaying an image for left eye and an image for right eye and comprising:
a left-eye selection part that switches to a transmission state of transmitting light or a blocking state of blocking light;
a right-eye selection part that switches to a transmission state of transmitting light or a blocking state of blocking light;
a tilt detection part that detects a tilt condition of the shutter glasses;
a signal acquisition part that acquires a left switch signal in synchronization with display timing of the image for left eye and a right switch signal in synchronization with display timing of the image for right eye from the image display device;
a tilt condition determination part that compares an output value of the tilt detection part and a predetermined threshold value; and
a switching operation part that switches the left-eye selection part and the right-eye selection part to the transmission state or the blocking state,
wherein, when the output value is less than the threshold value, the switching operation part switches only the left-eye selection part from the blocking state to the transmission state in response to acquisition timing of the left switch signal and switches only the right-eye selection part from the blocking state to the transmission state in response to acquisition timing of the right switch signal, and
when the output value is equal to or more than the threshold value, the switching operation part switches both the left-eye selection part and the right-eye selection part from the blocking state to the transmission state in response to acquisition timing of one of the left switch signal and the right switch signal.

2. The shutter glasses according to claim 1, further comprising:
a timing selection part that receives selection of one of the respective acquisition timing of the left switch signal and the right switch signal as the acquisition timing with which both the left-eye selection part and the right-eye selection part are switched to the transmission state,
wherein, when the output value is equal to or more than the threshold value, the switching operation part switches both the left-eye selection part and the right-eye selection part from the blocking state to the transmission state in response to the selected acquisition timing.

3. The shutter glasses according to claim 1,
wherein the tilt condition determination part determines a tilt direction of the shutter glasses based on the output value, and
when the output value is equal to or more than the threshold value, the switching operation part switches both the left-eye selection part and the right-eye selection part from the blocking state to the transmission state in response to the acquisition timing of a signal corresponding to the tilt direction of the left switch signal and the right switch signal.

4. An image display system comprising:
the shutter glasses according to claim 1; and
an image display device that alternately displays an image for left eye and an image for right eye, and includes
a display unit that displays the images,
a signal output unit that respectively outputs a left switch signal and a right switch signal in synchronization with respective display timing of the image for left eye and the image for right eye by the display unit, respectively, to the shutter glasses and
a control unit that controls the display unit and the signal output unit.

5. An image display system comprising:
the shutter glasses according to claim 2; and
an image display device that alternately displays an image for left eye and an image for right eye, and includes
a display unit that displays the images,
a signal output unit that respectively outputs a left switch signal and a right switch signal in synchronization with respective display timing of the image for left eye and the image for right eye by the display unit, respectively, to the shutter glasses and
a control unit that controls the display unit and the signal output unit.

6. An image display system comprising:
the shutter glasses according to claim 3; and
an image display device that alternately displays an image for left eye and an image for right eye, and includes
a display unit that displays the images,
a signal output unit that respectively outputs a left switch signal and a right switch signal in synchronization with respective display timing of the image for left eye and the image for right eye by the display unit, respectively, to the shutter glasses and
a control unit that controls the display unit and the signal output unit.

7. The image display system according to claim 4,
wherein the signal output unit respectively outputs the left switch signal and the right switch signal as linearly-polarized light,
the signal acquisition part includes plural light receiving parts that receive the left switch signal and the right switch signal,
the plural light receiving parts respectively receive only respective linearly-polarized components having different polarization directions from each other, and
the tilt detection part detects the tilt condition of the shutter glasses based on the left switch signal and the right switch signal respectively received by the plural light receiving parts.

8. The image display system according to claim 5,
wherein the signal output unit respectively outputs the left switch signal and the right switch signal as linearly-polarized light,
the signal acquisition part includes plural light receiving parts that receive the left switch signal and the right switch signal,
the plural light receiving parts respectively receive only respective linearly-polarized components having different polarization directions from each other, and
the tilt detection part detects the tilt condition of the shutter glasses based on the left switch signal and the right switch signal respectively received by the plural light receiving parts.

9. The image display system according to claim 6,
wherein the signal output unit respectively outputs the left switch signal and the right switch signal as linearly-polarized light,
the signal acquisition part includes plural light receiving parts that receive the left switch signal and the right switch signal,
the plural light receiving parts respectively receive only respective linearly-polarized components having different polarization directions from each other, and
the tilt detection part detects the tilt condition of the shutter glasses based on the left switch signal and the right switch signal respectively received by the plural light receiving parts.

10. An image display system comprising:
an image display device that alternately displays an image for left eye and an image for right eye; and
shutter glasses including
a left-eye selection part that alternately switch between a transmission state of transmitting light and a blocking state of blocking light,
a right-eye selection part that alternately switch between a transmission state of transmitting light and a blocking state of blocking light,
a tilt detection part that detects a tilt condition of the shutter glasses,
a tilt condition determination part that compares an output value of the tilt detection part and a predetermined threshold value, and
a switching operation part that alternately switches the left-eye selection part and the right-eye selection part to the transmission state and the blocking state,
when the output value is less than the threshold value, the switching operation part switches the left-eye selection part and the right-eye selection part between the transmission state and the blocking state so that only the left-eye selection part may be in the transmission state when the image display device displays the image for left eye and only the right-eye selection part may be in the transmission state when the image display device displays the image for right eye, and
when the output value is equal to or more than the threshold value, the switching operation part switches the left-eye selection part and the right-eye selection part between the transmission state and the blocking state so that both the left-eye selection part and the right-eye selection part may be in the transmission state only when the image display device displays the image for left eye or when the image display device displays the image for right eye.
